(19) United States
(12) Patent Application Publication
(10) Pub. No.: US 2011/0285895 A1
(43) Pub. Date: Nov. 24, 2011

(54) Image Sensing Device and Processing System

(75) Inventors: Ping Kuo Weng, Taoyuan County (TW); Yin Yi Wu, Changhua County (TW); Hsien Ming Wu, Taoyuan County (TW)

(73) Assignee: CHUNG SHAN INSTITUTE OF SCIENCE AND TECHNOLOGY, Taoyuan County (TW)

(21) Appl. No.: 12/784,720

(22) Filed: May 21, 2010

(51) Int. Cl. H04N 5/225; G06K 9/34

(52) U.S. Cl. 348/340; 348/342; 382/164; 348/E05.024

(57) ABSTRACT

An image sensing device includes a color filter array module and a controlling module. The color filter array module includes a first, a second, a third and a fourth filter unit. The first filter unit is used to sense a first pixel data at the frame; the second filter unit is used to sense a second pixel data at the frame; the third filter unit is used to sense a third pixel data at the frame; and the fourth filter unit is used to sense a narrow-band data. The controlling module controls the sensing and illuminating form of the color filter array module according to the first light or the second light. An image processing system reconstructs the full scale chromatic image and gray barrow-band image respectively after color filter array demosaicking process and synthesizes the chromatic image and narrow-band image into a color narrow-band image.

### BACKGROUND OF THE INVENTION

1. Field of the Invention

The present invention generally relates to an image sensing device and system, and more particularly, the image sensing device and system of the invention is capable of capturing a chromatic image, a gray narrow-band image, and a color narrow-band image on a screen synchronously.

2. Description of the Prior Art

Endoscope systems are generally used for medical treatment. The conventional endoscope device performs a shooting by invading a body directly, and it usually makes the patient feel uncomfortable. In recent years, with the development of technology and the progress of the integrated circuit process and the wireless transmission technology, the volume of an image sensor has been gradually reduced to form an endoscope in a capsule. Since the capsule endoscope can perform the shooting along gullet toward small intestine, the examiner can shoot the parts of the possible pathological changes in the patient body via controlling the wireless capsule endoscope, and judges the causes of the possible pathological changes according to the images. Accordingly, the defects of the conventional invading endoscope can be improved.

However, the image sensor of the general capsule endoscope is mainly used for getting the chromatic image. Please refer to FIG. 1A-1D. FIG. 1A-1D illustrate the color filter module 20 of the prior art respectively. As shown in FIG. 1A, the array of the color filter module 20 is the most commonly used array at present; the color filter module 20 includes a clear pixel, a yellow pixel, and a cyan pixel. Practically, the clear pixel includes a red pixel, a green pixel, and a blue pixel; the yellow pixel includes a red pixel and a blue pixel; the cyan pixel includes a green pixel and a blue pixel; the original red (R) pixel, the original green (G) pixel, and the original blue (B) pixel are generated by the variation of adjacent pixel intensity; finally, the original pixels are reduced to the chromatic image.

The color filter module 20 increases an infrared ray (IR) pixel in FIG. 1C. It can clear the IR effect of other RGB pixels via the electrical signal processing method; therefore, the system can reach the function without the IR capturing filter. In FIG. 1D, the cyan filter unit is added to the color filter module 20 to increase the color gamut of the chromatic image via a four-pixel array.

In practical applications, examiners usually discover that the chromatic image is unable to show the disease region clearly. That is because the primary cancer will grow on the vessel surface, and the hemoglobin has obvious absorption spectrum characteristics to the light with the wavelength of 415 nm and 540 nm. Although, the capsule endoscope can perform the shooting inside the small intestine presently, it only can shoot the chromatic image. As for the above-mentioned specific wave band image or narrow band image, they can not be captured so that the examiner can not make precise recognition according to the disease region.

### SUMMARY OF THE INVENTION

Accordingly, an aspect of the present invention is to provide an image sensing device and an image processing system therefrom, the image sensing device is used to sense a chromatic image and a gray level narrow-band image on the object surface; the image processing system reconstructs the full scale chromatic image and gray barrow-band image respectively after color filter array demosaicking process and synthesizes the chromatic image and narrow-band image into a color narrow-band image, so that an observer can not only observe the surface of the object according to the chromatic image, but also judge the unusual form of the object via the gray level narrow-band image with high contrast.

According to an embodiment of the invention, the image sensing device of the invention is capable of capturing a gray narrow-band image and a chromatic image on a frame via a mixing illumination of a first light and a second light. The image sensing device includes a color filter array module and a controlling module. The color filter array module includes a first filter unit, a second filter unit, a third filter unit, and a fourth filter unit. The first filter unit is located in a first region and used for sensing a first pixel of the frame. The second filter unit is located in a second region and near the first region; the second filter unit is used for sensing a second pixel of the frame. The third filter unit is located in the third region and near the second region; the third filter unit is used for sensing a third pixel of the frame. The fourth filter unit which is a clear film or a specific wavelength film is located in a fourth region and near the first region and the third region; the fourth filter unit is used for sensing a narrow band pixel of the frame.

In this embodiment, the controlling module is coupled to the color filter array module, the first light, and the second light; the controlling module is used for controlling sensing and illuminating forms of the color filter array module according to the first light or the second light. According to lighting method, the illumination mode can be separated into inter-illumination mode and intra-illumination mode. The inter-illumination mode capture a chromatic image at current frame n and capture a narrow band image in next frame n+1, whereas the intra-illumination mode capture a chromatic image and a narrow band image at the same frame n. When inter-illumination mode is activated, the first light source (narrow-band) performs illumination in frame n, then the controlling module starts the fourth filter unit to sense the narrow band pixel and also starts the first filter unit, the second filter unit, and the third filter unit to sense the first pixel, the second pixel, and the third pixel. Subsequently, the second light (multi-band) source performs illumination in frame n+1, then the controlling module starts the first filter unit, the second filter unit, the third filter, and the fourth filter unit to sense the first pixel, the second pixel, the third pixel, and the fourth pixel. As intra-illumination mode is activated, the second light source (white light) illustrates the sensor in frame n firstly; meanwhile, the fourth filter unit is disabled by the controlling module. The fourth filter unit is then enabled by the controlling module, and the first light source (narrow-band) starts illustrating the sensor behind the end of second light source at the same frame n. Afterward the controlling module enables the fourth filter unit to sense the narrow band pixel, and also enables the first filter unit, the second filter unit, and the third filter unit to sense the first pixel, the second pixel, and the third pixel.

In accordance with some embodiments of the present invention, the image processing system, wherein the image processing system is coupled to the image sensing device, for receiving the first pixel, the second pixel, and the third pixel to form the chromatic image, and/or receiving the fourth pixel to form the gray level barrow-band image respectively after color filter array demosaicking process. For both inter and intra illumination mode, the image processing system then assigns the G plane (demosaicked by G pixel) of chromatic image to the red plane of synthesized image and assigns the B plane (demosaicked by B pixel) of gray narrow-band image and the NB plane (demosaicked by NB pixel) of gray narrow-band image to either the blue or the green plane of synthesized image respectively to reform a high contrast color narrow-band image which include the information of chromatic image and gray narrow-band image. In inter-illumination mode, the color narrow-band image, for example a BMP format, is composed of one plane of the chromatic image (frame n+1) and two planes of the gray narrow-band image (frame n). In intra-illumination mode, all the three planes of synthesized image come from the same frame n.

To sum up, the image sensing device and system provided by the invention uses the filter unit array of the new-style color filter and controls the multi-band light and the narrow band light through the filter unit of the color filter to obtain each of band gray level images. Wherein, the gray level image of the red pixel, the green pixel, and the blue pixel can be reconstructed to be a full-band chromatic image, and the narrow band pixel will show the gray level narrow-band image with high contrast after synthesizing these multi-band images. Therefore, the image sensing device and system of the invention can synchronously or independently show different corresponding band images by the outer display device.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A-1D illustrate the color filter module of the prior art respectively.

FIG. 2A illustrates a schematic diagram of the image sensing device and system of the embodiment of the invention.

FIG. 2B illustrates a schematic diagram of color filter array module in FIG. 2A.

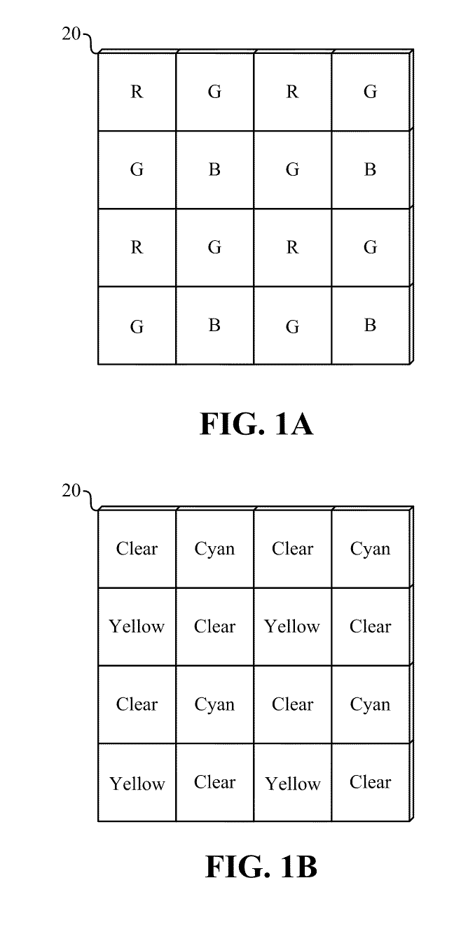

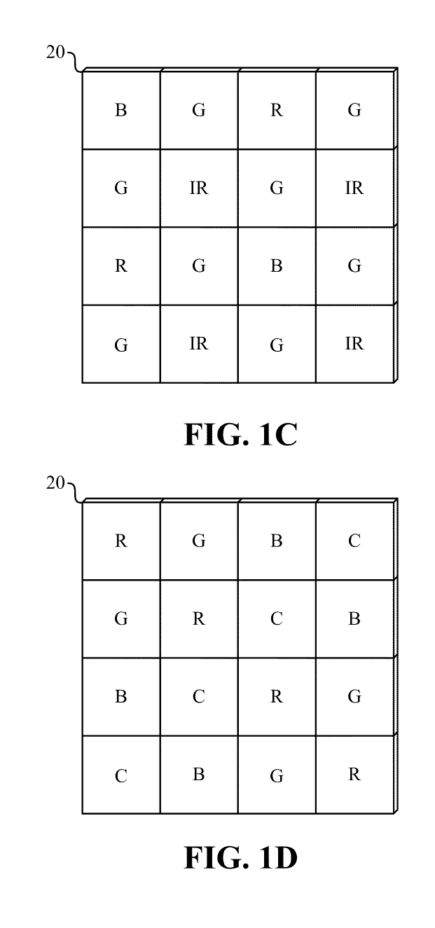

### DETAILED DESCRIPTION OF THE INVENTION

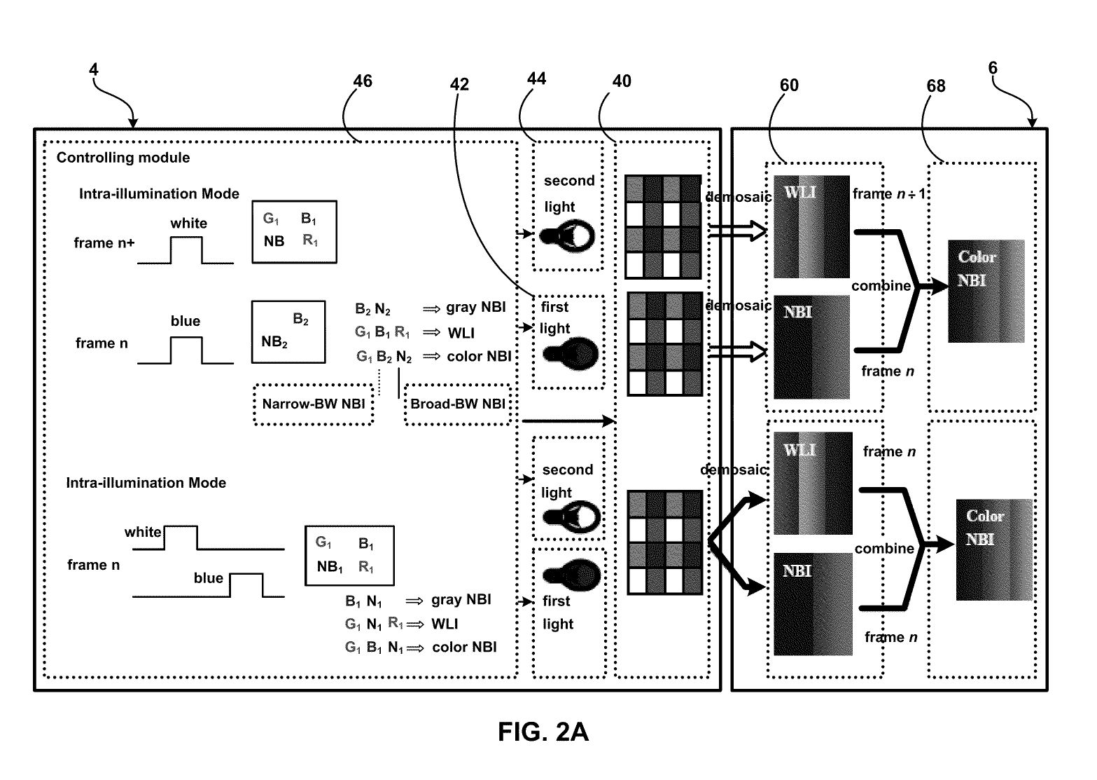

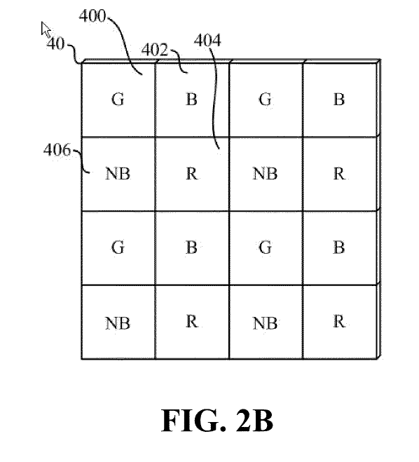

Please refer to FIG. 2A. FIG. 2A illustrates the schematic diagram of the image sensing device 4, an embodiment of the invention. Practically, the image sensing device 4 of the invention can be a charge coupled device (CCD) or a complementary metal-oxide semiconductor (CMOS), but not limited to this.

In this embodiment, the image sensing device 4 of the invention includes a color filter array module 40 and a controlling module 46. The color filter array module 40 can be directly formed on the surface of the image sensing device.

As shown in FIG. 2B, the color filter array module 40 includes the first filter unit 400, a second filter unit 402, a third filter unit 404 and a fourth filter unit 406. The first filter unit 400 is located in a first region, and the first filter unit 400 is used to sense a first pixel of the frame. The second filter unit 402 is located in a second region and near the first region, and the second filter unit 402 is used to sense a second pixel of the frame.

The third filter unit 404 is located in a third region and near the second region, and the third filter unit 404 is used to sense a third pixel of the frame. The fourth filter unit 406 which is a clear film or a specific wavelength film is located in a fourth region and near between the first region and the third region, and the fourth filter unit 406 is used to sense a narrow band pixel of the image.

In this embodiment, the illuminating light pass through the first filter unit 400(R) is almost red, the light pass through the first filter unit 402(B) is almost blue, and the light pass through the first filter unit 404(G) is almost green, the spectra are depend on the illustrative spectrum AND the filter spectrum. Therefore, the first pixel, the second pixel, and the third pixel of sensor can be defined to correspond to the R pixel, the B pixel, and the G pixel respectively. In practical applications, the first filter unit 400, the second filter unit 402, and the third filter unit 404 can be arranged as the array shown in FIG. 2B, but not limited to this order.

It should be noticed that the fourth filter unit surface can be plated with a specific wavelength film or a clear film. If the fourth filter is a specific wavelength film, the first light source could be a multi-band light source. On the contrary, if the fourth filter is a clear film, the first light source must be a narrow-band light source. Practically, the fourth filter unit 406 surface can be plated with the 415 nm center wavelength filter film or a clear filter film. If the fourth filter unit 406 surface is plated with the 415 nm center wavelength filter film, only the 415 nm light with a spectrum depend on the fourth filter can pass through the fourth filter unit 406 to form the gray level image; similarly, if the fourth filter unit 406 is not plated with any filter film, the light can fully pass through the fourth filter unit 406 to form the gray level image, wherein the image spectrum is depend on the spectrum of narrow-band illumination source.

In practical applications, the image sensing device 4 captures a gray level image and a chromatic image on a frame via a mixing illumination of a first light 42 and a second light 44. Wherein, the fourth filter is a clear film, the first light 42 is a narrow-band light, the second light 44 is a white light, and the first light 42 and the second light 44 can be a suitable light emitting diode (LED).

When inter-illumination mode is activated, the first light source (narrow-band) performs illumination in frame n, then the controlling module 46 starts the fourth filter unit to sense the narrow band pixel, and also starts the first filter unit, the second filter unit, and the third filter unit to sense the first pixel, the second pixel, and the third pixel.

Subsequently, the second light (multi-band) source performs illumination in frame n+1, then the controlling module 46 starts the first filter unit, the second filter unit, the third filter, and the fourth filter unit to sense the first pixel, the second pixel, the third pixel, and the fourth pixel.

When intra-illumination is used, the second light source (white light) illustrates the sensor in frame n firstly; meanwhile, the fourth filter unit is disabled by the controlling module. The fourth filter unit is then enabled by the controlling module 46, and the first light source (narrow-band) starts illustrating the sensor behind the end of second light source at the same frame n. Afterward the controlling module 46 enables the fourth filter unit to sense the narrow band pixel, and also enables the first filter unit, the second filter unit, and the third filter unit to sense the first pixel, the second pixel, and the third pixel. Since all the sensing pixels are exposed at the same frame, the sensing level of RGB units of the color filter array module 40 will be interfered by the first light except the narrow-band pixel. Therefore, in this embodiment, the following equations are used to compensate the level shifting by referring the neighboring NB pixel respectively, wherein the transmittance coefficient (tᵣ, t_{g}, and t_{b}) are used to correct the RGB pixels, and the values (R0, G0, and B0) are the sensing levels of R, G, and B pixels after this illuminating procedure.

R=R0−tᵣ×(NB(R)+NB(L))/2

G=R0−t_{g}×(NB(U)+NB(D))/2

B=B0−t_{b}×(NB(RU)+NB(RD))+NB(LU)+NB(LD))/4

In this embodiment, the controlling module 46 of the image sensing device 4 is coupled to the color filter array module 40, the first light 42, and the second light 44. The controlling module 46 can control a sensing form of the color filter array module 40 according to the first light 42 or the second light 44. Additionally, the controlling module 46 can control the illumination manner of the first light 42 and the second light 44 according the color filter array module 40. In practical applications, the narrow band image technology outperforms the inspection aiming at the pathological changes of gastrointestinal tract in the human body, and the cell lesion less than 5 mm of the diameter will be easily recognized in the gastrointestinal tract according to the narrow band light. Compared to the white light luminance, the narrow band light can help the observer inspect the early cancer symptom more efficiently.

Please refer to FIG. 2A. FIG. 2A illustrates the schematic diagram of the image processing system 6 that is another embodiment of the invention. As shown in FIG. 2A, the image processing system 6 includes an image demosaicking device 60 and a data process device 68.

The image demosaicking device 60 is used to demosaic a gray level mosaic image and a chromatic mosaic image, where the mosaic images are generated from the previous color filter array. In practically, the image demosaicking device 60 could be a bi-linear interpolation method, a weighted-sum method, or a Laplacian method etc. If inter-illumination mode is adopted, and the fourth filter is a clear pixel, and the center wavelength of narrow-band light source is 415 nm. The chromatic image is composed of R1, G1, and B1 pixels, and the gray narrow-band image is composed of B2, NB2 pixels, as shown in FIG. 2. If intra-illumination mode is adopted, and the fourth filter is a clear pixel, and the center wavelength of narrow-band light source is 415 nm. The chromatic image is composed of R1, G1, and B1 pixels after the level shift correcting process, and the gray narrow-band image is composed of B1, NB1 pixels, as shown in FIG. 2A. In fact, the chromatic image and the gray level narrow-band image can be shown on the display synchronously after the demosaicking device 60, so that the examiner can judge whether the patient has any lesion in his small bowel according to the chromatic image and the gray level narrow-band image.

The data process device 68 is used for superposing the chromatic image (white light image), and/or the gray level narrow-band image to form a high contrast synthesized color narrow-band image. The data process device 68 can superpose the sub-planes of chromatic image and gray level narrow-band image to provide a high contrast color narrow-band image which includes the information of the chromatic image and the gray level narrow-band image. In practically, the format of chromatic and gray narrow-band images are BMP, and the sub-plane used for color narrow-band image synthesizing depends on the illumination mode and the fourth filter of color filter array. In fact, for both illumination modes, wherein the fourth filter is a clear pixel, and the center wavelength of narrow-band light source is 415 nm, the data process device 68 puts the G pixel (plane) of chromatic image, the B pixel of narrow-band image and the NB pixel of narrow-band image into the R, G, and B plane (not limited to this order) of color narrow-band image respectively.

Compared to the prior art, the image sensing device and system provided by the invention uses the filter unit array of the new-style color filter and controls the multi-band light and the narrow band light through the filter unit of the color filter to obtain each of band gray level images. Wherein, the gray level image of the red pixel, the green pixel, and the blue pixel can be reconstructed to be a full-band chromatic image, and the gray narrow-band image combined the chromatic image will show a high contrast color narrow-band image. Therefore, the image sensing device and system of the invention can synchronously or independently show different band images by the outer display device.

Although the present invention has been illustrated and described with reference to the preferred embodiment thereof, it should be understood that it is in no way limited to the details of such embodiment but is capable of numerous modifications within the scope of the appended claims.

What is claimed is:

1. An image sensing device, for capturing a narrow-band image and a chromatic image on a frame via a mixing illumination of a first light and a second light, the image sensing device comprising:
a color filter array module, comprising:
a first filter unit, located in a first region, for sensing a first pixel of the frame;
a second filter unit, located in a second region and near the first region, for sensing a second pixel of the frame;
a third filter unit, located in a third region and near the second region, for sensing a third pixel of the frame; and
a fourth filter unit, located in a fourth region and near the first region and the third region, for sensing a narrow band pixel of the frame; and
a controlling module, coupled to the color filter array module, the first light, and the second light, for controlling the sensing form and the illuminating form of the color filter array module according to the first light or the second light.

2. The image sensing device of claim 1, wherein the first light is a narrow band light and the second light is a white light.

3. The image sensing device of claim 1, in accordance with center wavelength of light source and illumination mode, wherein when the first light performs exposure, the controlling module starts adequate filters unit to sense the narrow band pixel and generates the gray level image with high contrast according to the narrow band pixel.

4. The image sensing device of claim 1, in accordance with its illumination mode, wherein when the second light performs exposure, the controlling module starts the first filter unit, the second filter unit, and the third filter unit to sense the first pixel, the second pixel, and the third pixel, and generates the chromatic image according to the first pixel, the second pixel, and the third pixel.

5. The image sensing device of claim 1, wherein the first pixel, the second pixel, and the third pixel are correspond to a red pixel, a blue pixel, and a green pixel respectively.

6. The image sensing device of claim 1, wherein the fourth filter unit is plated with a specific wavelength film or a clear film.

7. The image sensing device of claim 1, wherein the image sensing device is a charge coupled device (CCD) or a complementary metal-oxide semiconductor (CMOS).

8. An image processing system, comprising:
an image demosaicking device, for demosaicking a mosaic image to a full scale color image and a full scale narrow-band image; and
an image data process device, for superposing the chromatic image and the gray level narrow-band image to form a synthesized color narrow-band image which include the information of chromatic image and gray narrow-band image.

9. The image processing system of claim 8, wherein when inter-illumination mode is adopted, and the fourth filter is a clear pixel, and the center wavelength of narrow-band light source is 415 nm. The image demosaicking device generates a chromatic image which is composed of R1, G1, and B1 pixels, and a gray narrow-band image which is composed of B2, NB2 pixels.

10. The image processing system of claim 8, wherein when inter-illumination mode is adopted, and the fourth filter is a clear pixel, and the center wavelength of narrow-band light source is 540 nm. The image demosaicking device generates a chromatic image which is composed of R1, G1, and B1 pixels, and a gray narrow-band image which is composed of G2, NB2 pixels.

11. The image processing system of claim 8, wherein when intra-illumination mode is adopted, and the fourth filter is a clear pixel, and the center wavelength of narrow-band light source is 415 nm. The image demosaicking device generates a chromatic image which is composed of R1, G1, and B1 pixels after the level shift correcting process, and a gray narrow-band image which is composed of B1, NB1 pixels.

12. The image processing system of claim 8, wherein when intra-illumination mode is adopted, and the fourth filter is a clear pixel, and the center wavelength of narrow-band light source is 540 nm, the image demosaicking device generates a chromatic image which is composed of R1, G1, and B1 pixels after the level shift correcting process, and a gray narrow-band image is composed of G1, NB1 pixels.

13. The image processing system of claim 8, wherein the fourth filter is a clear pixel, and the center wavelength of narrow-band light source is 415 nm, the data process device puts the G pixel (plane) of chromatic image, the B pixel of narrow-band image and the NB pixel of narrow-band image into the R, G, and B plane (not limited to this order) of color narrow-band image respectively.

14. The image processing system of claim 8, wherein the fourth filter is a clear pixel, and the center wavelength of narrow-band light source is 540 nm, the data process device puts the B pixel (plane) of chromatic image, the G pixel of narrow-band image and the NB pixel of narrow-band image into the R, G, and B plane (not limited to this order) of color narrow-band image respectively.
